(19) United States
(12) Patent Application Publication
(10) Pub. No.: US 2002/0165294 A1
(43) Pub. Date: Nov. 7, 2002

(54) Luminescent coating

(76) Inventors: William Robert Cooper, Kilcreggan (GB); Howard Mitchell Jess, Glasgow (GB)

Correspondence Address: MERCHANT & GOULD PC, P.O. BOX 2903, MINNEAPOLIS, MN, 55402-0903, US

(21) Appl. No.: 09/958,189

(22) PCT Filed: Mar. 16, 2001
(86) PCT No.: PCT/GB01/01151

(30) Foreign Application Priority Data
Oct. 3, 2000 (GB) 0024164.6

(51) Int. Cl. B05D 5/12; C09D 5/29

(52) U.S. Cl. 523/171; 427/8; 523/172

(57) ABSTRACT

A method of detecting the quality or damage and/or deterioration of a coating when applied to a clean surface, the coating (6) consisting essentially of a paint into which is mixed a luminescent pigment additive which is less than 10% by weight, the luminescent additive being much less than that used for known luminescent paints where the level of luminescent pigment is as much as 45%. The coating (6) is illuminated by means of a projector (4) with ultraviolet light; the coating then being viewed for gaps or variations in the intensity of the luminescence of the image. The image is then preferably digitally recorded for detailed analysis and subsequent reference. The coating and method are advantageously used on surfaces which are difficult to view, such as ships' ballast tanks or tall structures such as bridges.

The present invention relates to a coating such as a paint, to a method of detecting the quality of the coating and also the use of the coating to detect subsequent damage or deterioration to the coating.

Coatings on metal surfaces, whether for marine, industrial or domestic uses, rely heavily on the quality, of the initial application for their performance. Factors affecting this application such as surface preparation, coating thickness and continuity, number of coats as well as subsequent coating damage caused by heat, abrasion, climate and impacts must be taken into account when considering performance.

For marine or aircraft uses, particularly military equipment, the quality of the application of the coating is especially important. In high performance military aircraft coating damage due to corrosion and bird strikes is sometimes difficult to detect.

The inspection and survey of coatings on aircraft, sea going vessels, underwater sections of offshore drilling rigs and production platforms as well as land installations such as oil and chemical storage tanks, reaction vessels in industrial plant, rail tank cars and the like is time consuming and therefore costly, both in terms of the skilled manpower used in the inspection itself, but also in terms of the time out of service of the inspected unit. Owing to the complicated nature of some of the structures it is also almost impossible to carry out an adequate survey of vital parts of the structure with any degree of certainty as to the completeness of the survey.

Following the Exxon Valdez disaster, legislation such as the U.S. Oil Pollution Act of 1990 and International Marine Pollution Regulations (MARPOL) have required a large increase in the water ballast tank and double hull areas of tankers, all requiring robust coatings. Recently bulk carriers have likewise suffered a number of sinkings so that classification societies such as Lloyds Register have focussed attention on periodic surveys of the coating condition of hulls of such vessels and have developed suitable hull condition monitoring programs. When building one of these large ships as much as 14% of the total time required may be allocated to coating. Subsequent annual repair costs due to corrosion of marine tanks in U.S. Navy vessels for example is estimated by the U.S. Navy itself at US$64 million. The U.S. Navy also predicts that if this coat could be cut by a better quality of initial application and inspection the savings would reach US$2.03 billion over the next 20 years.

Japanese Patent Publication No 02024366 (Application No 63175950) assigned to Dainippon and Shinroihi describes using a zinc-rich coating material with a fluorescent pigment to detect imperfections. The problem with this fluorescent additive is that fluorescent pigments dissolve into the coating so that unless there is a sufficiently high level of pigment, the pigment could Well be quenched by the colouring pigment and furthermore, the Fluorescent pigment, when it is sufficient to be useful, in turn tends to alter the colour of the coating. Either way, this is an undesirable situation.

Japanese Publication 11061115 (Lonseal Corp) also discloses the use of fluorescent pigments within coating compositions which can emit bright visible light on UC irradiation but this has the same disadvantages as those exhibited by JP 02024366.

A further Japanese Patent Publication JP 11158420 (Mind) again uses fluorescent pigments with the above disadvantages and where the fluorescent pigments are at a very high level of up to 50% to produce the necessary luminous effect. Such a high level would be undesirable for the present purposes because of the effect on the colour of the coating.

British Patent Publication No GB 2,133,701 A discloses the use of fluorescent pigments in coatings for golf balls. Again, the fluorescent pigment tends to alter the colour coating and this is admitted by the applicant Sumitomo Rubber Industries Limited. Generally, the fluorescent pigments appear to be limited to using zinc-based fluorescent pigments. Luminescent pigments differ from fluorescent pigments in not being absorbed within the coating and as a result, perform better in the dark where fluorescent pigments are generally ineffective without a high level of irradiation.

According to a first aspect, the invention provides a coating comprising a paint, preferably an epoxy based paint into which is mixed a luminescent pigment additive less than 10% and preferably less than 1% by weight.

Luminescent paints as such normally have greater than 30% of luminescent pigments introduced and typically the level of luminescent pigment is as much as 45% by weight. Spanish Patent No 538468 (ES 008601283) to J and J C Sanchez describes a luminescent paint of this kind where the luminescent pigment is 30 to 65% by weight. Thus the coating of the invention can by no means be classifiable as a luminescent paint.

The coating of the invention, comprising a paint, may be oil based rather than the preferred epoxy base.

According to a second aspect of the invention, there is provided a method of detecting the quality of the application or the coating according to the first aspect of the invention comprising applying the coating of the first aspect of the invention to a clean surface, illuminating the coating with ultraviolet light and viewing the luminescent image so produced for gaps and/or variations in the intensity of the luminescence of the image.

Clearly the gaps indicate failure to provide a complete or unbroken coating, whereas brighter or weaker luminescence indicates thicker or thinner areas of the coating.

The ultraviolet illumination of the coating provided in the second aspect of the invention should firstly be carried out during the initial application of the coating since this assists the applicator in identifying and covering any area he has missed, and also to increase to the correct level the thickness of the coating where thinness is identified by the ultraviolet illumination. The illumination provided by the second aspect of the invention should secondly be carried out by the inspectors of the coating to similarly identify areas of missing coverage of the coating, thin areas in the coating, damage to the coating, etc.

The Image of the coating so illuminated with ultraviolet light as provided by the second aspect of the invention should in a preferred example be digitally recorded by a suitable camcorder device as permanent evidence for surveys and for subsequent checking of the coating for damage or deterioration. These digitally recorded records can be readily stored for long periods, easily moved from construction point to head offices and used as evidence of completion of construction or maintenance contracts, and later used as comparison with later surveys of the same structure to determine areas or extent of coating damage, erosion or deterioration.

As provided in the preferred example of the invention, as set out above, it is possible by noting the exact, distance of the digital equipment recording the levels of luminescence from the ultraviolet illuminated coating being examined and comparing the readings with a table of values derived from that particular coating, to determine the thickness of the coating, thus indicating whether the coating is thicker or thinner than the desired standard. For this purpose the recording apparatus should be calibrated either before or after recording the luminescent image. Calibration may be made either by viewing an uncoated surface or by viewing a coating of paint lacking the luminescent pigment additive.

The method of the invention has been further discovered to indicate damage to aerospace vehicles, particularly those used for high velocity defense purposes where bird strikes or similar damage occurs to a surface coating of the coating of the invention. The method and coating of the invention has also been discovered to reveal damage to coatings resulting from welding or other sources of heat affecting opposite side of the metal from the coating. The method and coating of the Invention will be useful in applying and Inspecting coatings on metal or other surfaces in a wide range of situations, including any type of tank or storage compartment where a high degree of integrity of the coating (internal or external), is necessary. Examples would include chemical tanks, reaction vessels, ships ballast tanks, rail tank cars, and many others.

The coating and method of the invention is also useful in applying and removing shop primer paints applied to steel shapes and plates used in heavy construction. Such initial protective coatings must be completely removed before the final coatings are applied and such complete removal can be facilitated and checked by use of the invention.

It is noted that the coating and method of the invention also functions underwater so long as the illuminating ultraviolet light and recording apparatus are suitably waterproofed. The invention is thus useful for coating and inspecting such underwater structures as pipelines, bridge supports and offshore oil installations of all types. It will also function as a cost efficient means of checking the rate and amount of erosion of the antifouling coatings on the bottoms of ships' hulls without drydocking the vessel.

Further investigation using the coating and method of the invention may reveal a further use as an indicator of stressed or cracked welded joints or seams in metals.

The economic advantages of the invention are compelling. Complete refurbishment of the ballast tank surfaces in a very large crude carrier currently costs about US$1.2 million so that any increase in life expectancy of the coatings is bound to result in considerable cost savings. It will be appreciated that the method of the invention is equally able to discover overcoating as well as undercoating. Furthermore, since inspection time may take up to 14% of the total coating time for new ship construction, any reduction in the time required for both the inspection as well as any remedial painting necessitated by the inspection must also result in significant cost reductions.

An embodiment of the invention will now be described by way of an example with reference to the accompanying drawings in which:

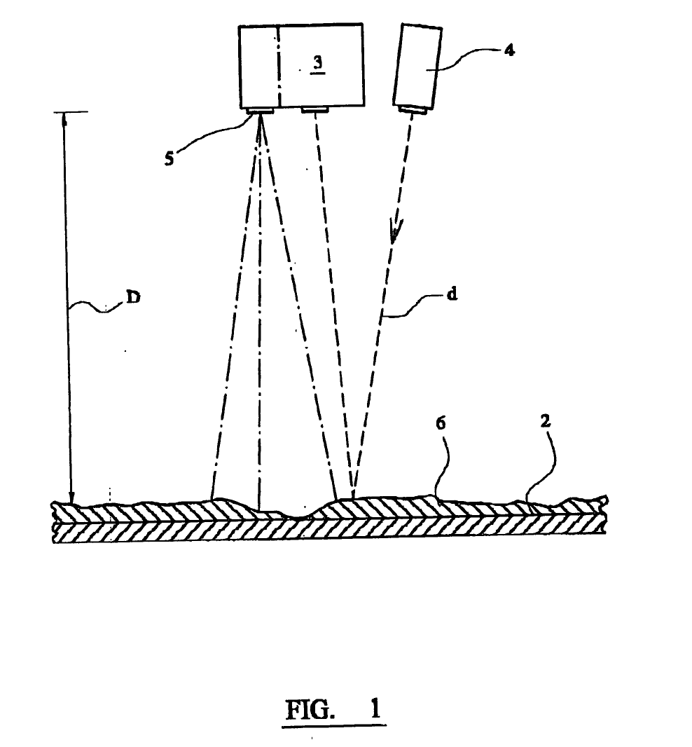

FIG. 1 is a diagram of a coating quality detecting: method according to the invention.

Prior to coating, for example, a ship's ballast tank, a proprietary paint suitable for the application, in this case a marine grade epoxy based paint, has added to it luminescent pigment (an optically active additive—OAA) in a proportion by weight of less than 10% and preferably lees than 1% of the epoxy based paint.

Ballast tank surface 2 is then illuminated by ultraviolet (UV) light at 360 nm from projector 4 Fixed at a known distance from surface 2. A digital camera 3 with a fixed optical meter 5 is fixed at a known distance from surface 2. The UV sensitive meter 5 is then calibrated to “zero coatings”. Zero coating is deemed to be indexed to 100.

The epoxy paint With OAA is then applied as coating 6 and protector 4 is then switched on and shone all over the coating to see if darker areas show this coating or very dark patches show holidays. Thin or absent coating can be recorded by directing the meter 5 at the defective area and the calibrated meter will then read slightly less than 100 or 100 for zero coating. The defects can then be remedied and a recording of the coating can be finally made by the digital camera 3 with a coincident meter recording, which should show the 100 according to a predetermined table derived from the paint manufacturer. This enables the coating's thickness to be recorded swiftly without resort to conventional complicated and time consuming methods.

If required, a second non-luminescent coating can be applied over coating 5 and the same monitoring technique can be used to detect pin holes or holidays showing up brightly through the second coating.

A recent series of trials of the coating according to the invention has shown this to be particularly useful in coatings used to mark standing timber where, in the past, ordinary paint has been used to mark timber to be cut, which has been abused by forestry workers who bring their own pots of paint to mark additional trees to achieve a higher felling output. This fraudulent use of marking paint can be detected by using coatings of the invention.

It should be understood that the specific form of the invention herein above described is intended to be representative only since modifications within the scope of these teachings will be apparent to those skilled in the art. All such modifications and variations are believed to be within the sphere and scope of the present invention as defined by the following claims.

1. A coating comprising a paint into which is mixed a luminescent pigment additive, less than 10% by weight.

2. A coating according to claim 1 wherein the paint is an epoxy based paint.

3. A coating according to claim 1 comprises an oil based paint.

4. A coating according to claim 1 wherein the additive is less than 1% by weight.

5. A method of detecting the quality or damage and/or deterioration to the coating of claim 1 comprises applying the coating according to any one of claims 1 to 4, to a clean surfaces illuminating the said coating with ultraviolet light and viewing the luminescent image so produced for gaps or variations in the intensity of the luminescence of the image.

6. A method according to claim 5 wherein the image is digitally recorded.

7. A method according to claim 6 wherein the distance from the image to recording equipment used for the digital recording is measured and wherein the levels of luminescence from the image are compared with a table having predetermined value for the known thicknesses of said luminescent paint, used as a standard so as to determine the thickness of the coating.

8. A method according to claim 5 wherein the ultraviolet light used is at a wave length of about 360 nm.

9. A method of detecting the quality of application of a coating or damage or deterioration to a coating substantially as described with reference to the accompanying drawing.
